(19) United States
(12) Patent Application Publication
(10) Pub. No.: US 2024/0428175 A1
(43) Pub. Date: Dec. 26, 2024

(54) CONTROL DEVICE, CONTROL METHOD, AND STORAGE MEDIUM

(71) Applicant: TOYOTA BOSHOKU KABUSHIKI KAISHA, Aichi-ken (JP)

(72) Inventors: Rina MUKAI, Aichi (JP); Tokuyuki NISHIKAWA, Aichi (JP); Richard CHUNG, Aichi (JP)

(73) Assignee: TOYOTA BOSHOKU KABUSHIKI KAISHA, Aichi-ken (JP)

(21) Appl. No.: 18/741,233

(22) Filed: Jun. 12, 2024

(30) Foreign Application Priority Data
Jun. 20, 2023 (JP) 2023-100999

(51) Int. Cl. G06Q 10/083

(52) U.S. Cl. CPC G06Q 10/083

(57) ABSTRACT

A control device determines, on a basis of (i) an arrival time when a vehicle will arrive at a destination desired by a and (ii) a period of delivery time it takes for a drone to deliver, to the vehicle, a product ordered by the user who is traveling in the vehicle, whether or not it is possible for the drone to deliver the product to the vehicle before the vehicle arrives at the destination.

This Nonprovisional application claims priority under 35 U.S.C. $119 on Patent Application No. 2023-100999 filed in Japan on Jun. 20, 2023, the entire contents of which are hereby incorporated by reference.

### TECHNICAL FIELD

The present disclosure relates to a control device, a control method, and a storage medium.

### BACKGROUND ART

Patent Literature 1 discloses a delivery system that delivers, with use of a drone, a product ordered by a user.

### CITATION LIST

### Patent Literature

### [Patent Literature 1]

Japanese Patent Application Publication, Tokukai, No. 2020-90152

### SUMMARY OF INVENTION

### Technical Problem

However, the invention disclosed in Patent Literature 1 is a system that delivers, with use of a drone, a product to a user's residence; and Patent Literature 1 does not mention delivering a product to a user who is traveling.

An aspect of the present disclosure has an object to deliver a product to a user who is traveling.

### Solution to Problem

In order to attain the above object, a control device in accordance with an aspect of the present disclosure is a control device including a controller, the controller determining, on a basis of (i) an arrival time when a vehicle will arrive at a destination desired by a user and (ii) a period of delivery time it takes for a drone to deliver, to the vehicle, a product ordered by the user who is traveling in the vehicle, whether or not it is possible for the drone to deliver the product to the vehicle before the vehicle arrives at the destination.

In order to attain the above object, a control method in accordance with an aspect of the present disclosure is a control method for use in a control device including a controller, the control method including the step of: determining, on a basis of (i) an arrival time when a vehicle will arrive at a destination desired by a user and (ii) a period of delivery time it takes for a drone to deliver, to the vehicle, a product ordered by the user who is traveling in the vehicle, whether or not it is possible for the drone to deliver the product to the vehicle before the vehicle arrives at the destination.

In order to attain the above object, a storage medium in accordance with an aspect of the present disclosure is a computer-readable storage medium having a control program stored therein, the control program causing a computer to execute a process of determining, on a basis of (i) an arrival time when a vehicle will arrive at a destination desired by a user and (ii) a period of delivery time it takes for a drone to deliver, to the vehicle, a product ordered by the user who is traveling in the vehicle, whether or not it is possible for the drone to deliver the product to the vehicle before the vehicle arrives at the destination.

A control device in accordance with an aspect of the present disclosure can be realized by a computer. In this case, the present disclosure encompasses: a control program for causing a computer to function as each of the sections (software elements) included in the control device so as to realize the control device by the computer; and a computer-readable storage medium having the control program stored therein.

### Advantageous Effects of Invention

In accordance with an aspect of the present disclosure, it is possible to deliver a product to a user who is traveling.

### BRIEF DESCRIPTION OF DRAWINGS

FIG. 1 is a view schematically illustrating a configuration of an example of a delivery management system in accordance with an embodiment of the present disclosure.

FIG. 2 is a view illustrating an example method for receiving a load from a drone.

FIG. 3 is a block diagram illustrating a hardware configuration of a first management server.

FIG. 4 is a block diagram illustrating a hardware configuration of a second management server.

FIG. 5 is a block diagram illustrating a hardware configuration of a control device of a vehicle.

FIG. 6 is a block diagram illustrating a hardware configuration of a user terminal.

FIG. 7 is a view illustrating an appearance of a drone.

FIG. 8 is a block diagram illustrating a hardware configuration of a control device of the drone.

FIG. 9 is a flowchart of a process of the delivery management system.

FIG. 10 is a flowchart of a process of the delivery management system.

FIG. 11 shows an example of an order screen via which a user orders a product.

FIG. 12 is map information indicating a traveling route along which a vehicle travels to a destination.

FIG. 13 is map information indicating a traveling route along which a vehicle travels to a destination.

### DESCRIPTION OF EMBODIMENTS

The following description will discuss, with reference to the drawings, a delivery management system 100 in accordance with an embodiment of the present disclosure. The same parts in the drawings are given the same reference numerals, and descriptions thereof will be omitted.

### (Configuration of Delivery Management System 100)

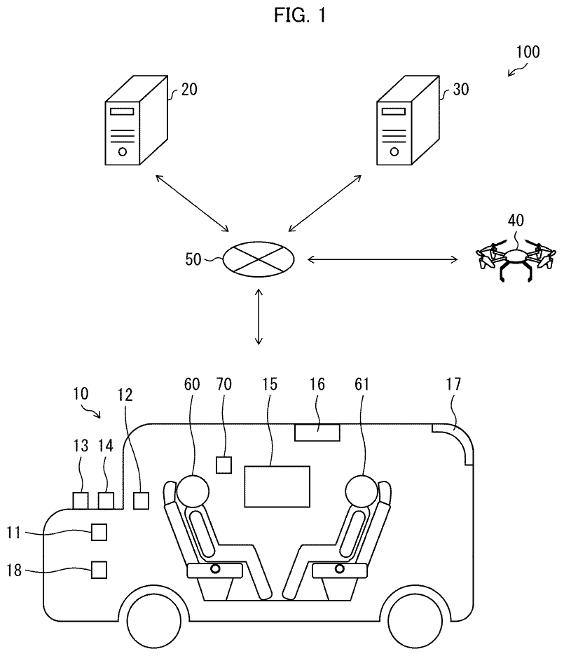

The delivery management system 100 is a system with which a product ordered by user who is in a vehicle is delivered to the user with use of a drone. FIG. 1 is a view schematically illustrating a configuration of an example of the delivery management system 100.

As shown in FIG. 1, the delivery management system 100 includes: a vehicle 10 used in a ridesharing service; a first management server 20 managed and operated by a business operator of the ridesharing service; a second management server 30 managed and operated by a business operator of a food delivery service; a drone 40 that is a flying moving body; a communication network 50; and a user terminal 70 owned by a user 60 who is in the vehicle 10.

In FIG. 1, one vehicle 10 is shown. However, this is not limitative. The delivery management system 100 may include two or more vehicles. Further, in FIG. 1, one drone 40 is shown. However, this is not limitative. The delivery management system 100 may include two or more drones. Moreover, in FIG. 1, one user terminal 70 is shown. However, this is not limitative. The delivery management system 100 may include two or more user terminals. For example, the delivery management system 100 may include, in addition to the user terminal 70 owned by the user 60, a user terminal owned by the user 61. In a case where the business operator managing the ridesharing service and the business operator managing the food delivery service are the same, the first management server 20 and the second management server 30 may be a single server. The service provided by the business operator managing and operating the second management server 30 is not limited to the food delivery service, but may be a delivery service for daily necessities, medical and pharmaceutical products, and/or the like.

The vehicle 10 and the drone 40 each include a control device, which will be described later. The control device of the vehicle 10, the first management server 20, the second management server 30, the control device of the drone 40, and the user terminal 70 are communicable with each other via the communication network 50.

In the present embodiment, the vehicle 10 is described as a vehicle used in the ridesharing service. However, this is not limitative. Alternatively, the vehicle 10 may be a vehicle for private use. In the present embodiment, the vehicle 10 is described as a vehicle having an autonomous driving function. Assume that the autonomous driving function of the vehicle 10 does not require passenger's monitoring. That is, an assumed level of autonomous driving is 3 or higher. However, this is not limitative. The vehicle 10 may be a vehicle not having an autonomous driving function. Two users, that is, the user 60 and the user 61 are in the vehicle 10. Alternatively, three or more users may be in the vehicle 10.

The vehicle 10 includes a control device 11, a GPS receiver 12, a camera 13, a sensor set 14, a display 15, a ceiling module 16, an opening and closing module 17, and an actuator 18.

The control device 11 controls the actuator 18 according to information obtained from the GPS receiver 12, the camera 13, and the sensor set 14 so as to realize autonomous driving. The actuator 18 includes a brake actuator, an accelerator pedal actuator, a steering actuator, and the like. The control device 11 has a function to control actions of the ceiling module 16 and the opening and closing module 17 so as to receive a load from the drone 40.

The GPS receiver 12 receives a radio wave from an artificial satellite so as to obtain position information of the vehicle 10 on the earth. The position information of the vehicle 10 obtained by the GPS receiver 12 is transmitted to the control device 11.

The camera 13 includes an image capturing element such as charge-coupled device (CCD) and/or complementary metal oxide semiconductor (CMOS). The number of cameras 13 and the place of the camera 13 are not particularly limited. For example, the cameras 13 are provided at a front position, a side position, and a rear position of the vehicle 10. The camera 13 captures an image of an area surrounding the vehicle 10 at a given cycle to detect information on the area surrounding the vehicle 10. The information on the area surrounding the vehicle 10 includes information relating to a pedestrian, a bicycle, a motorcycle, another vehicle, and/or the like and information relating to a carriageway marking, a signal, a sign, a pedestrian crossing, an intersection, and/or the like. The information on the area surrounding the vehicle 10, detected by the camera 13, is transmitted to the control device 11.

The sensor set 14 includes a sensor for detecting a state of the vehicle 10 and a sensor for detecting the information on the area surrounding the vehicle 10. Examples of the sensor for detecting the state of the vehicle 10 include a speed sensor, an accelerator sensor, a steering sensor, a gyro sensor, a brake hydraulic sensor, and an accelerator opening sensor. Examples of the sensor for detecting the information on the area surrounding the vehicle 10 include a millimetric wave radar and a light detection and ranging (LiDAR). LiDAR is a sensor that measures a period of time it takes for laser light emitted to an object in the area surrounding the vehicle 10 to reach and return from the object, thereby measuring a distance and a direction to the object and/or recognizing a shape of the object. The state of the vehicle 10 and the information on the area surrounding the vehicle 10 detected by the sensor set 14 are transmitted to the control device 11.

The display 15 is a device that displays various information.

The ceiling module 16 is a module movable in an interior of the vehicle along a rail (not illustrated) provided to the ceiling of the interior of the vehicle. The “module” herein means a part having a given function.

The opening and closing module 17 is a module provided to a part of the roof of the vehicle 10 and is configured to be capable of opening and closing an opening, which is a part of the roof. In the example shown in the present embodiment, the opening and closing module 17 is provided at a rear end of the roof. Alternatively, the opening and closing module 17 may be provided at a center or a front end of the roof.

The communication network 50 described here is the Internet. However, limitative. Alternatively, the communication network 50 may be any of the other radio communication networks.

### (Method for Receiving Load)

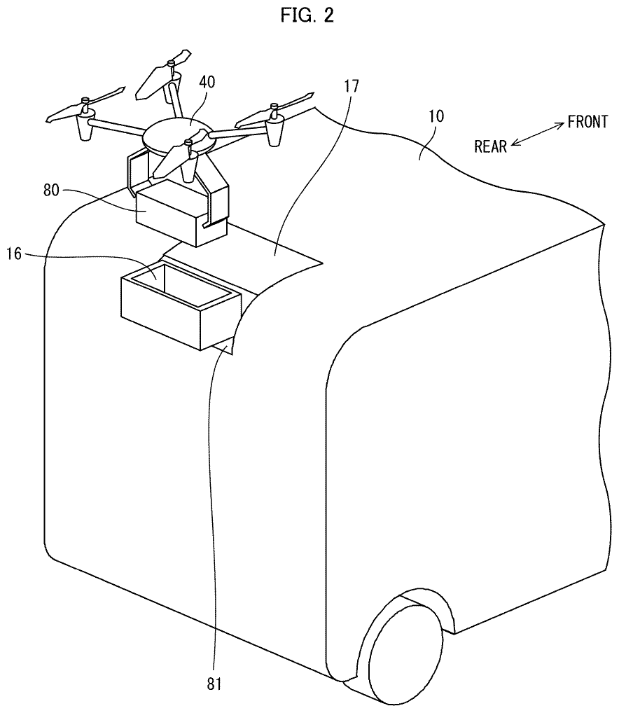

Next, the following description will discuss, with reference to FIG. 2, an example of a method for receiving a load 80 from the drone 40. FIG. 2 shows a scene in which the ceiling module 16 of the vehicle 10 receives the load 80 carried by the drone 40. The load 80 is a product that the user 60 has ordered with the user terminal 70 via the Internet.

Upon detection of arrival of the load 80, the control device 11 of the vehicle 10 causes the opening and closing module 17 to slide toward the front side of the vehicle 10 so as to open the opening 81, which is a part of the roof.

The control device 11 of the vehicle 10 causes the ceiling module 16 to move from the opening 81 toward the outside of the vehicle 10. The ceiling module 16 has a rectangular parallelepiped box shape and has an opened upper side. This allows the load 80 to be placed in the ceiling module 16 through the upper side of the ceiling module 16. After placing the load 80 in the ceiling module 16, the drone 40 opens its arms with which the load 80 was held. Delivering the load 80 in this manner prevents falling of the load 80, thereby preventing a damage of the load 80.

The present embodiment assumes that the series of the process in which the user 60 orders a product via the Internet and the process in which the drone 40 delivers a load 80, which is the ordered product, is carried out while the vehicle 10 is traveling toward a destination. Here, depending on the condition, the drone cannot always deliver the load 80 before the vehicle 10 arrives at the destination. In order to deal with this, the present embodiment has the following configuration. That is, it is determined whether or not it is possible for the drone 40 to deliver the load 80 before the vehicle 10 arrives at the destination. Then, if it is determined possible, the drone 40 is caused to deliver the load 80.

### (Hardware Configuration of First Management Server 20)

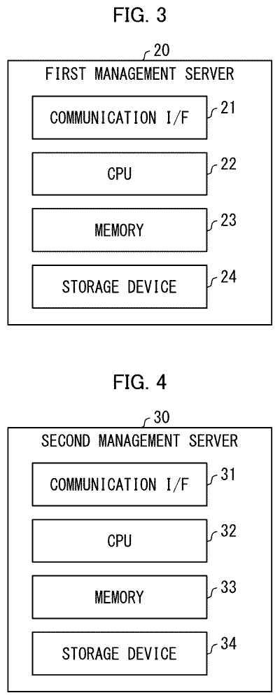

Next, the following description discuss, with reference to FIG. 3, an example of a hardware configuration of the first management server 20. FIG. 3 is a block diagram illustrating the hardware configuration of the first management server 20.

As shown in FIG. 3, the first management server 20 is a general-purpose computer including a communication interface (I/F) 21, a Central Processing Unit (CPU) 22, a memory 23, and a storage device 24. These constituent elements are electrically connected to each other via a bus (not illustrated).

The communication I/F 21 is implemented as hardware such as a network adapter, various communication software, or a combination of them, and is configured to realize radio communication carried out via the communication network 50.

The CPU 22 is a central processing unit and is a controller that executes various programs. The memory 23 is a storage medium such as a Read Only Memory (ROM) or a Random Access Memory (RAM). The storage device 24 is constituted by a Hard Disk Drive (HDD), a Solid State Drive (SSD) a flash memory, or the like, and has various programs and various data stored therein. Specifically, in the storage device 24, account information (e.g., a user ID and/or a password) for utilizing the ridesharing service, use history, and/or the like is/are stored.

### (Hardware Configuration of Second Management Server 30)

Next, the following description discuss, with reference to FIG. 4, an example of a hardware configuration of the second management server 30. FIG. 4 is a block diagram illustrating the hardware configuration of the second management server 30.

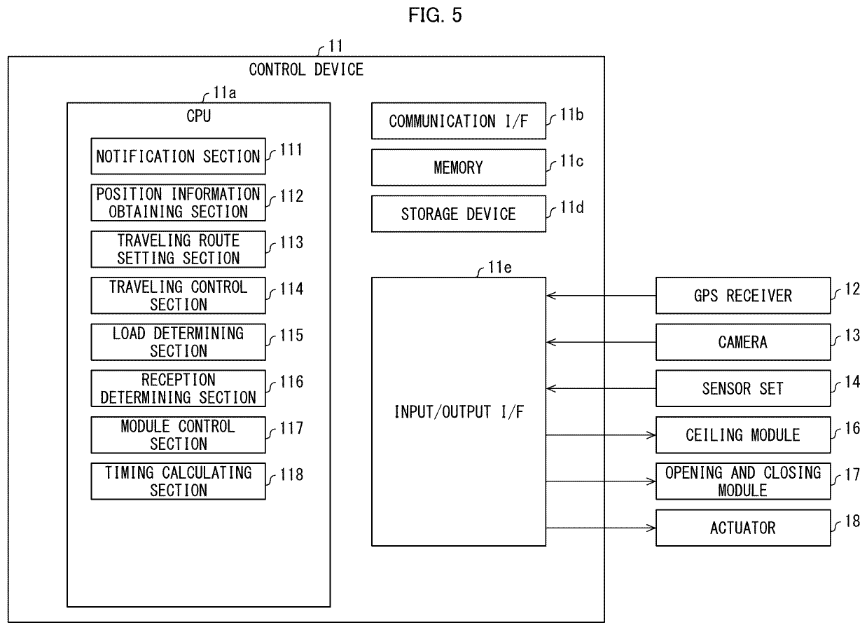

As shown in FIG. 5, the second management server 30 is a general-purpose computer including a communication interface (I/F) 31, a CPU 32, a memory 33, and a storage device 34. These constituent elements are electrically connected to each other via a bus (not illustrated). Configurations of the communication I/F 31, the CPU 32, the memory 33, and the storage device 34 are identical to those of the communication I/F 21, the CPU 22, the memory 23, and the storage device 24 of the first management server 20 described above. Therefore, descriptions thereof will be omitted.

In the storage device 34, account information (e.g., a user ID and/or a password) for utilizing the food delivery service, a store(s) registered in the food delivery service, a menu(s) provided by the store(s), and/or the like is/are stored.

### (Hardware Configuration of Control Device 11 of Vehicle 10)

Next, the following description will discuss, with reference to FIG. 5, an example of a hardware configuration of the control device 11 of the vehicle 10. FIG. 5 is a block diagram illustrating a hardware configuration of the control device 11 of the vehicle 10.

As shown in FIG. 5, the control device 11 of the vehicle 10 is a general-purpose computer including a communication I/F 11b, a CPU 11a, a memory 11c, a storage device 11d, and an input/output I/F 11e. These constituent elements are electrically connected to each other via a bus (not illustrated). Configurations of the communication I/F 11b, the CPU 11a, the memory 11c, and the storage device 11d are identical to those of the communication I/F 21, the CPU 22, the memory 23, and the storage device 24 of the first management server 20 described above. Therefore, descriptions thereof will be omitted.

The input/output I/F 11e is an interface used to communicate with the GPS receiver 12, the camera 13, the sensor set 14, the ceiling module 16, the opening and closing module 17, and the actuator 18 mounted on the vehicle 10. This interface may be the one employing a communication standard which is in compliance with a controller area network (CAN) protocol, for example.

In the control device 11 of the present embodiment, the CPU 11a executes a given program stored in the storage device 11d to function as a notification section 111, a position information obtaining section 112, a traveling route setting section 113, a traveling control section 114, a load determining section 115, a reception determining section 116, a module control section 117, and a timing calculating section 118.

The notification section 111 notifies given information to the drone 40 or the user 60. The position information obtaining section 112 obtains position information from the GPS receiver 12, and outputs the obtained position information to the traveling control section 114.

The traveling route setting section 113 sets a traveling route to a destination desired by the user 60, and outputs the set traveling route to the traveling control section 114. The traveling control section 114 controls the actuator 18 so as to cause the vehicle 10 to travel along the traveling route obtained from the traveling route setting section 113.

The load determining section 115 determines whether or not the load 80 carried by the drone 40 is the product ordered by the user 60. The reception determining section 116 determines whether or not it is possible to receive the load 80.

The module control section 117 controls operation of the ceiling module 16 and the opening and closing module 17. In a case where the reception determining section 116 determines that it is impossible to receive the load 80, the timing calculating section 118 calculates a timing suitable for reception of the load 80.

### (Hardware Configuration of User Terminal 70)

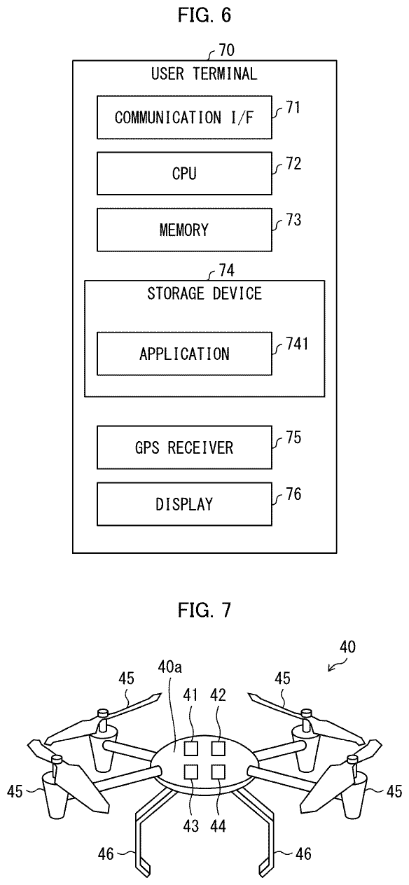

Next, the following description discuss, with reference to FIG. 6, an example of a hardware configuration of the user terminal 70. FIG. 6 is a block diagram illustrating the hardware configuration of the user terminal 70.

The user terminal 70 is a device owned by the user 60 who utilizes the ridesharing service and who is on the vehicle 10. The present embodiment assumes that the user terminal 70 is a smartphone. However, this is not limitative. The user terminal 70 may be a tablet terminal or a wearable device.

As shown in FIG. 6, the user terminal 70 includes a communication I/F 71, a CPU 72, a memory 73, a storage device 74, a GPS receiver 75, and a display 76. These elements are electrically connected to each other via a bus (not illustrated). Configurations of the communication I/F 71, the CPU 72, the memory 73, and the storage device 74 are identical to those of the communication I/F 21, the CPU 22, the memory 23, and the storage device 24 of the first management server 20 described above. Therefore, descriptions thereof will be omitted.

In the storage device 74, an application 741 for utilizing the ridesharing service and the food delivery service is installed. Hereinafter, the above application 741 will be simply referred to as an “application 741”. The application 741 is realized by the CPU 72 reading out a dedicated application program from the storage device 74 and executing the application program.

The display 76 is constituted by, e.g., a liquid crystal display or an organic electroluminescent (EL) display, and displays various information. The display 76 has a capacitive type touch sensor, and also functions as an input device that accepts a touch operation of the user 60 as an input operation.

### (Drone 40)

Next, the following description will discuss the drone 40 with reference to FIG. 7. FIG. 7 is a view illustrating an appearance of the drone 40.

As shown in FIG. 7, the drone 40 includes a main body 40a, four propellers 45 connected to the main body 40a, and a single set of arms 46 connected to the main body 40a. The main body 40a includes a control device 41, a GPS receiver 42, a camera 43, and a sensor set 44. Note that the number of propellers is not limited to four. The number of propellers may be any number, provided that it can realize stable flight. The number of sets of arms may be two or more.

The GPS receiver 42 obtains position information of the drone 40 by receiving a radio wave from an artificial satellite. The position information of the drone 40 obtained by the GPS receiver 42 is transmitted to the control device 41.

The camera 43 includes an image capturing element such as charge-coupled device (CCD) and/or complementary metal oxide semiconductor (CMOS). The camera 43 captures an image of an area surrounding the drone 40 at a given cycle to detect information on the area surrounding the drone 40. The information on the area surrounding the drone 40 includes, for example, weather and/or brightness of the area surrounding the drone 40 and/or an obstacle(s) such as a tree and/or a bird existing in front of the drone 40. The information on the area surrounding the drone 40 detected by the camera 43 is transmitted to the control device 41.

The sensor set 44 includes a sensor for detecting a state of the drone 40 and a sensor for detecting the information on the area surrounding the drone 40. Examples of the sensor for detecting the state of the drone 40 include a speed sensor, an accelerator sensor, and a gyro sensor. Examples of the sensor for detecting the information on the area surrounding the drone 40 include an ultrasonic sensor and an atmospheric pressure sensor. The state of the drone 40 and the information on the area surrounding the drone 40 detected by the sensor set 44 are transmitted to the control device 41.

The control device 41 controls the propellers 45 on the basis of the GPS receiver 42, the camera 43, and the sensor set 44 so as to cause the drone 40 to fly.

### (Hardware Configuration of Control Device 41 of Drone 40)

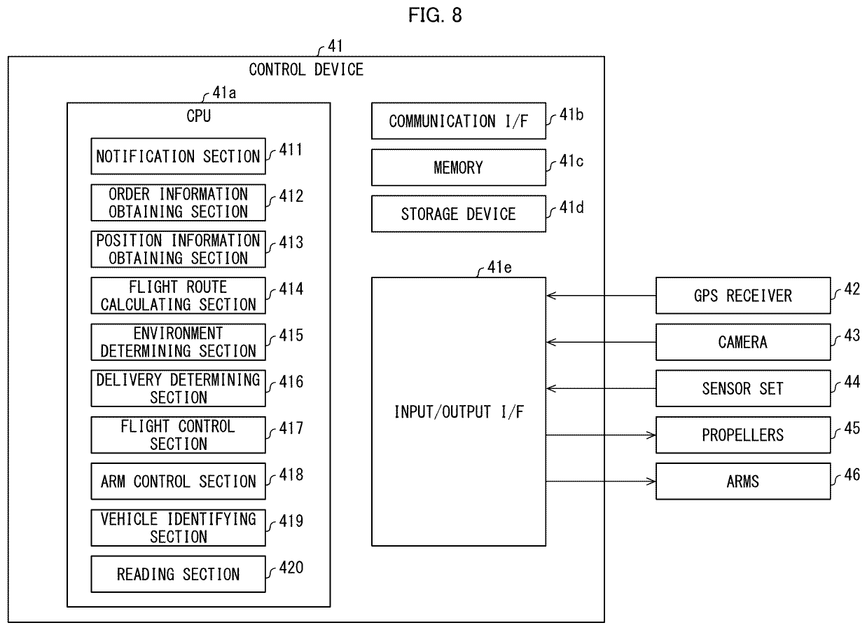

Next, the following description will discuss, with reference to FIG. 8, an example of a hardware configuration of the control device 41 of the drone 40. FIG. 8 is a block diagram illustrating a hardware configuration of the control device 41 of the drone 40.

As shown in FIG. 8, the control device 41 of the drone 40 is a general-purpose computer including a communication I/F 41b, a CPU 41a, a memory 41c, a storage device 41d, and an input/output I/F 41e. These constituent elements are electrically connected to each other via a bus (not illustrated). Configurations of the communication I/F 41b, the CPU 41a, the memory 41c, and the storage device 41d are identical to those of the communication I/F 21, the CPU 22, the memory 23, and the storage device 24 of the first management server 20 described above. Therefore, descriptions thereof will be omitted.

The input/output I/F 41e is an interface used to communicate with the GPS receiver 42, the camera 43, the sensor set 44, the propellers 45, and the arms 46 mounted on the drone 40.

In the control device 41 of the present embodiment, the CPU 41a executes a given program stored in the storage device 41d to function as a notification section 411, an order information obtaining section 412, a position information obtaining section 413, a flight route calculating section 414, an environment determining section 415, a delivery determining section 416, a flight control section 417, an arm control section 418, a vehicle identifying section 419, and a reading section 420.

The notification section 411 notifies given information to the vehicle 10 or the user 60. The order information obtaining section 412 obtains, from the second management server 30, information relating to an order made by the user 60.

The position information obtaining section 413 obtains position information from the GPS receiver 42, and outputs the obtained position information to the flight control section 417. The flight route calculating section 414 calculates a flight route to the vehicle 10, and outputs the calculated flight route to the flight control section 417.

The environment determining section 415 determines an environment around the drone 40. Specifically, on the basis of the information obtained from the camera 43 and the sensor set 44, the environment determining section 415 determines the weather and brightness in the area surrounding the drone 40 and/or the presence or absence of a tree, a bird, and/or the like in the area surrounding the drone 40.

The delivery determining section 416 determines whether or not it is possible to deliver the load 80 to the vehicle 10 before the vehicle 10 arrives at the destination. Considering an environment around the drone 40, the flight control section 417 causes the drone 40 to fly along the flight route calculated by the flight route calculating section 414.

The arm control section 418 controls the arms 46 so as to cause the arms 46 to grasp the load 80. The vehicle identifying section 419 identifies, through a known image processing technique analysis such as pattern matching, the vehicle 10 to which the load 80 is to be delivered. The reading section 420 reads, by the camera 43, a Quick Response (QR) code (registered trademark) attached to the vehicle 10 to obtain information embedded in the QR code (registered trademark).

### (Flow of Process Executed by Delivery Management System 100)

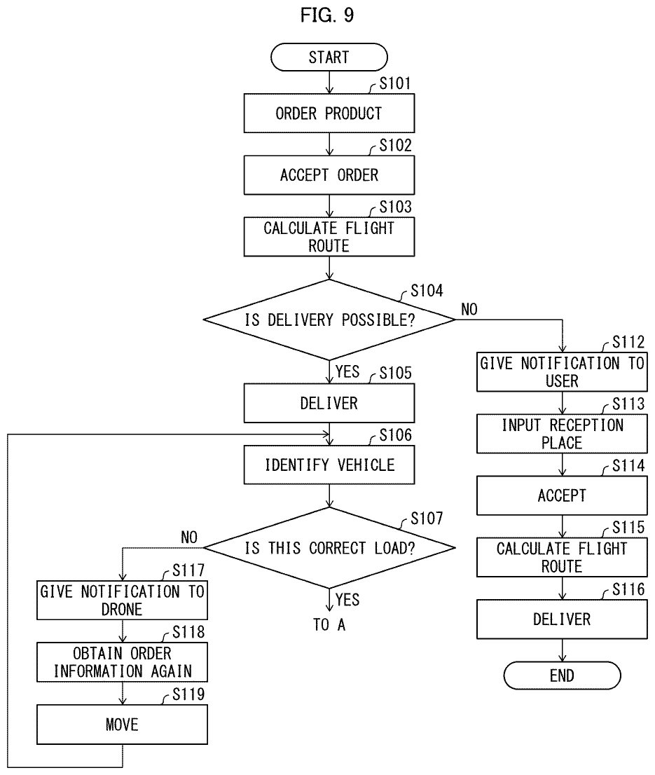

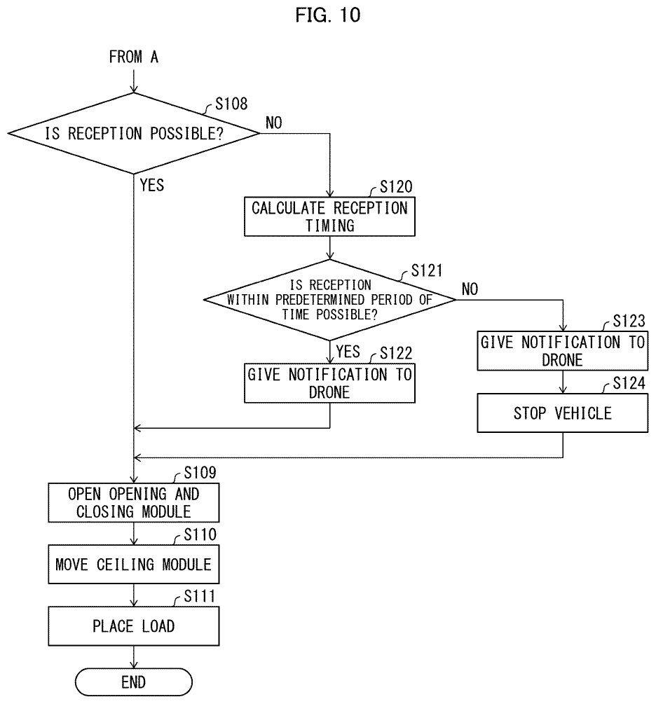

Next, the following description will discuss, with reference to flowcharts shown in FIGS. 9 and 10, an example of a flow of a process executed by the delivery management system 100. The processes in the flowcharts are executed, for example, in a scene in which a product ordered by the user 60 who is in the vehicle 10 is delivered to the vehicle 10 by the drone 40 and the product is received from the drone 40. A precondition for the flowcharts is that the user 60 is utilizing the ridesharing service and is in the vehicle 10.

In step S101, the user 60 who is in the vehicle 10 uses an application 741 to (i) select a desired store from among available stores and to (ii) choose and order desired food and/or drink from a menu provided by the store. The information relating to the store selected by the user 60 and the order from the menu is transmitted to the first management server 20.

In step S102, the first management server 20 obtains the information relating to the order transmitted in the process in step S101 so as to accept the order made by the user 60. In the present embodiment, the business operator operating the ridesharing service and the business operator operating the food delivery service are in corporation with each other, and thus can share the information of the user 60 who utilizes the ridesharing service and the food delivery service. Specifically, the first management server 20 can share with the second management server 30 in information relating to the ridesharing service. Examples of such information include: (1) information indicating whether or not the user 60 who has made the order is utilizing the ridesharing service; (2) information indicating a manufacturer of a vehicle on which the user rides (if the user is utilizing the ridesharing service); (3) information indicating a place where the vehicle is currently traveling; and (4) information indicating a destination.

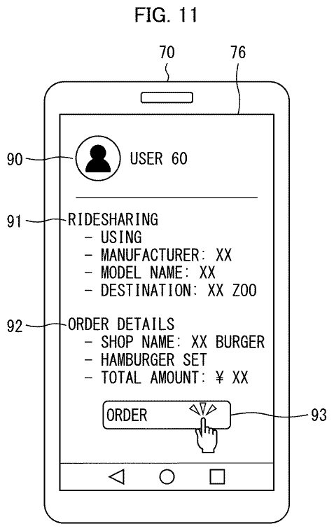

Here, the following description will discuss, with reference to FIG. 11, an example of an order screen via which the user 60 orders food and drink. The order function is a function provided by the application 741, and an order is made via the application 741. As shown in FIG. 11, when the user 60 is ordering food and drink, the display 76 of the user terminal 70 displays an icon 90 indicating that the user 60 is currently logging in the application 741, a notification 91 indicating whether or not the user 60 is currently utilizing the ridesharing service, and a notification 92 relating to a content of the order.

As shown in the notification 91, the display 76 displays information indicating that the user 60 is currently utilizing the ridesharing service, a manufacturer name and a model name of the vehicle 10 on which the user 60 rides, and a destination. The information relating to the notification 91 is information transmitted from the first management server 20 to the second management server 30 when the user 60 carries out touch operation on the icon 93 to make an order.

Returning to FIG. 9, in step S102, the first management server 20 transmits the information relating to the accepted order and the information relating to the ridesharing service to the second management server 30. The second management server 30 transmits the information relating to the order to the store selected by the user 60, the control device 41 of the drone 40 provided to that store, and the control device 11 of the vehicle 10. An employee of the store prepares the food and drink ordered by the user 60, and causes the drone 40 to deliver the food and drink.

In step S103, the control device 41 of the drone 40 calculates, on the basis of the information received in the process in step S102, a flight route from the store to the vehicle 10. Specifically, the control device 41 of the drone 40 calculates the flight route from the store to the vehicle 10 by using position information of the vehicle 10 received from the second management server 30.

In step S104, the control device 41 of the drone 40 determines whether or not it is possible to deliver the load 80 to the vehicle 10 before the vehicle 10 arrives at the destination.

### (Example of Method for Determining Whether or not Delivery is Possible)

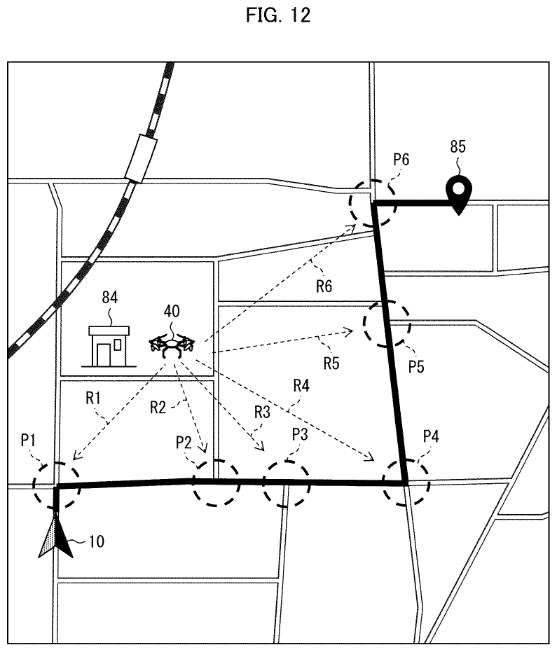

The following description will discuss, with reference to FIG. 12, a specific method for making the determination in step S104.

FIG. 12 is map information indicating a traveling route along which the vehicle 10 travels to a destination 85. P1 to P6 in FIG. 12 respectively indicate specific points through which the vehicle 10 passes before the vehicle 10 arrives at the destination 85. The specific points are each a candidate for a location where the load 80 from the drone 40 is received, and are set as appropriate. There is no particular limitation on the specific points. However, for example, each of the specific points may be an intersection where a traffic signal exists. The reason why such a point is selected is considered as follows. That is, while the vehicle 10 stops at red light, it is relatively easy to receive the load 80.

The control device 11 of the vehicle 10 calculates (i) a time when the vehicle will arrive at the destination 85 and (ii) times when the vehicle will pass through the respective points P1 to P6. The time thus calculated is one of the pieces of information relating to the ridesharing service, and is transmitted from the second management server 30 to the control device 41 of the drone 40.

A store 84 in FIG. 12 is a store selected by the user 60. The drone 40 is provided to the store 84.

After obtaining the information relating to the order made by the user 60, the control device 41 of the drone 40 calculates (i) the flight routes R1 to R6 each extending from the store 84 to a respective one of the points P1 to P6 and (ii) times when the drone will arrive at the respective points P1 to P6. Note that each of the flight routes R1 to R6 is a flight route along which the drone can arrive at a respective one of the points P1 to P6 most quickly.

Assume that (i) the current time is 10:00 and (ii) times when the vehicle 10 will pass through the respective points P1 to P6 and a time when the vehicle 10 will arrive at the destination 85 are calculated as follows. That is, the time when the vehicle 10 will pass through the point P1 is 10:05. The time when the vehicle 10 will pass through the point P2 is 10:10. The time when the vehicle 10 will pass through the point P3 is 10:15. The time when the vehicle 10 will pass through the point P4 is 10:20. The time when the vehicle 10 will pass through the point P5 is 10:25. The time when the vehicle 10 will pass through the point P6 is 10:30. The time when the vehicle 10 will arrive at the destination 85 is 10:35.

Further, assume that times when the drone 40 will arrive at the respective points P1 to P6 are calculated as follows. That is, the time when the drone 40 will arrive at the point P1 is 10:10. The time when the drone 40 will arrive at the point P2 is 10:08. The time when the drone 40 will arrive at the point P3 is 10:10. The time when the drone 40 will arrive at the point P4 is 10:15. The time when the drone 40 will arrive at the point P5 is 10:10. The time when the drone 40 will arrive at the point P6 is 10:15. That is to say, a period of delivery time it takes for the drone to arrive at each of the points P1, P3, and P5 is 10 minutes, a period of delivery time it takes for the drone to arrive at the point P2 is 8 minutes, and a period of delivery time it takes for the drone to arrive at each of the points P4 and P6 is 15 minutes.

In a case where the arrival times are calculated as above, the drone 40 cannot deliver the load 80 to the vehicle 10 at the point P1. The reason is that, when the drone 40 arrives at the point P1, the vehicle 10 has already passed through the point P1. Note that the example shown in FIG. 12 has the following precondition: speeds of the vehicle 10 and the drone 40 are almost the same, and the drone 40 cannot catch up with the vehicle 10 unless the vehicle 10 slows down or stops at red light. However, if a maximum speed allowed for the drone 40 is sufficiently higher than a legal speed for the vehicle 10, the drone 40 can catch up with the vehicle 10.

Meanwhile, the drone 40 can deliver the load 80 to the vehicle 10 at any one of the points P2 to P6. The reason is that, when the drone 40 arrives at one of the points P2 to P6, the vehicle 10 has not arrived at the one of the points P2 to P6 yet.

Therefore, for any one of the flight routes R2 to R6, the control device 41 of the drone 40 determines that it is possible to deliver the load 80 to the vehicle 10 before the vehicle 10 arrives at the destination 85 (YES in step S104).

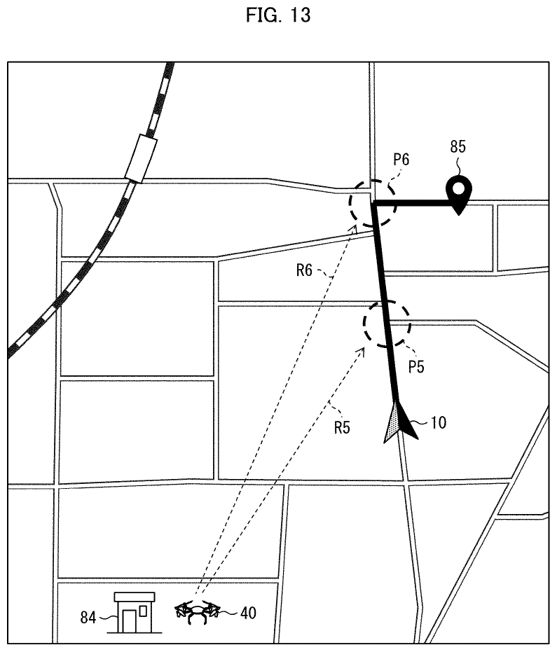

In the example described with reference to FIG. 12, for some of the flight routes, it is determined that it is possible to deliver the load 80 before the vehicle 10 arrives at the destination 85. The “some of the flight routes” are the flight routes R2 to R6. In contrast, in an example described below with reference to FIG. 13, for any flight route, it is determined that it is impossible to deliver the load 80 before the vehicle 10 arrives at the destination 85.

FIG. 13 is, similarly to FIG. 12, map information indicating a traveling route along which the vehicle 10 travels to the destination 85. FIG. 13 differs from FIG. 12 in the current location of the vehicle 10 and the location of the store 84.

Similarly to FIG. 12, FIG. 13 also assumes that (i) the current time is 10:00 and (ii) times when the vehicle 10 will pass through the respective points P5 and P6 and a time when the vehicle 10 will arrive at the destination 85 are calculated as follows. That is, the time when the vehicle 10 will pass through the point P5 is 10:25. The time when the vehicle 10 will pass through the point P6 is 10:30. The time when the vehicle 10 will arrive at the destination 85 is 10:35.

Further, assume that times when the drone 40 will arrive at the respective points P5 and P6 are calculated as follows. That is, the time when the drone 40 will arrive at the point P5 is 10:30. The time when the drone 40 will arrive at the point P6 is 10:35. That is to say, a period of delivery time it takes for the drone to arrive at the point P5 is 30 minutes, and a period of delivery time it takes for the drone to arrive at the point P6 is 35 minutes.

In a case where the arrival times are calculated as above, the drone 40 cannot deliver the load 80 to the vehicle 10 at either of the point P5 or P6. The reason is that, when the drone 40 arrives at the point P5 or P6, the vehicle 10 has already passed through the point P5 or P6.

Therefore, the control device 41 of the drone 40 determines that it is impossible to deliver the load 80 to the vehicle 10 before the vehicle 10 arrives at the destination 85 (NO in step S104).

In FIGS. 12 and 13, the points P1 to P6 are each set as a candidate for a location where the load 80 is received from the drone 40. However, it is not necessary to set such a point. In a case where such a point is not set, the control device 41 of the drone 40 may compare the arrival time when the vehicle 10 will arrive at the destination 85 with the period of delivery time of the drone 40 to determine whether or not it is possible to deliver the load 80 to the vehicle 10 before the vehicle 10 arrives at the destination 85. For example, if the end of the period of delivery time is earlier than the arrival time, the control device 41 of the drone 40 may determine that it is possible to deliver the load 80 to the vehicle 10 before the vehicle 10 arrives at the destination 85.

Note that an entity that makes the determination in step S104 is not limited to the control device 41 of the drone 40. For example, the control device 11 of the vehicle 10 may make the determination in step S104. In order that the control device 11 of the vehicle 10 makes the determination in step S104, the control device 11 of the vehicle 10 may obtain, from the drone 40, times when the drone 40 will arrive at the respective points P1 to P6.

It is possible to make the determination in step S104, given that (i) times when the vehicle 10 will pass through the respective points P1 to P6 and (ii) times when the drone 40 will arrive at the respective points P1 to P6 are made clear. Thus, the determination in step S104 may be made by the user terminal 70, the first management server 20, or the second management server 30.

In the present embodiment, the control device 11 of the vehicle 10, the first management server 20, the second management server 30, the control device 41 of the drone 40, and the user terminal 70 are communicable with each other via the communication network 50; therefore, each of the devices can obtain (i) times when the vehicle 10 will pass through the respective points P1 to P6 and (ii) times when the drone 40 will arrive at the respective points P1 to P6. Therefore, each of the devices can make the determination in step S104.

If it is determined that it is possible to deliver the load 80 (YES in step S104), the process advances to step S105. Then, the control device 41 of the drone 40 causes the drone 40 to fly along the flight route calculated in the process in step S103.

The process advances to step S106. Then, the control device 41 of the drone 40 which has arrived at a delivery point of the load 80 identifies, on the basis of an image captured by the camera 43, the vehicle 10 to which the load 80 is to be delivered. The delivery point of the load 80 refers to, for example, any one of the points P2 to P6 shown in FIG. 12. At the delivery point of the load 80, the control device 41 of the drone 40 needs to identify, from among traveling vehicles, the vehicle 10 to which the load 80 is to be delivered.

The following description will discuss an example of a method for identifying the vehicle 10 to which the load 80 is to be delivered. The control device 41 of the drone 40 knows the model name of the vehicle 10 to which the load 80 is to be delivered, since the control device 41 has obtained the model name from the second management server 30 (see FIG. 12). Further, the storage device 41d of the drone 40 stores therein a shape of the vehicle 10. Thus, the control device 41 of the drone 40 can compare, by pattern matching, (i) a shape of the vehicle in the image captured by the camera 43 at the delivery point of the load 80 and (ii) the shape of the vehicle 10 stored in the storage device 41d, thereby identifying, as the vehicle 10 to which the load 80 is to be delivered, a vehicle whose shape matches or substantially matches the shape of the vehicle 10 stored in the storage device 41d.

The process advances to step S107. Then, the control device 41 of the drone 40 causes the camera 43 to capture an image of a QR code (registered trademark) attached to the vehicle 10 identified in the process in step S106, so as to obtain information embedded in the QR code (registered trademark).

The purpose of obtaining the information from the QR code (registered trademark) attached to the vehicle 10 in the process in step S107 is to check whether or not the load 80 carried by the drone 40 is the product ordered by the user 60. The control device 41 of the drone 40 transmits, to the control device 11 of the vehicle 10, the information relating to the ridesharing service obtained from the second management server 30 and the information embedded in the QR code (registered trademark). The “information relating to the ridesharing service” includes the manufacturer name and model name of the vehicle 10 on which the user 60 who has ordered the product of the load 80 rides, as discussed above (see FIG. 11). The “information embedded in the QR code (registered trademark)” is, for example, the manufacturer name and model name of the vehicle 10 to which the QR code (registered trademark) is attached.

The control device 11 of the vehicle 10 compares the information relating to the ridesharing service obtained from the control device 41 of the drone 40 with the information embedded in i the QR code (registered trademark); then, if these pieces of information match, the control device 11 of the vehicle 10 determines that the load 80 carried by the drone 40 is the product ordered by the user 60 (YES in step S107).

The process in step S107 is effective when two or more vehicles of the same manufacturer and the same model are traveling side by side. In a case where two or more vehicles of the same manufacturer and the same model are traveling side by side, any of these vehicles can be identified, in the process of step S106, as the vehicle to which the load 80 is to be delivered. In this case, there is a possibility that the drone 40 may deliver the load 80 to a vehicle to which the load 80 should not be delivered. In order to deal with this, the present embodiment is configured to check whether or not the load 80 carried by the drone 40 according to the information of the QR code (registered trademark) attached to the vehicle is the product ordered by the user 60. With this, even in a case where two or more vehicles of the same manufacturer and the same model are traveling side by side, it is possible to deliver the load 80 to a vehicle to which the load 80 should be delivered.

Note that the information obtained by the control device 41 of the drone 40 in the process in step S107 is not limited to the information of the QR code (registered trademark), but may be information of a number plate. The information obtained by the control device 41 of the drone 40 only needs to be information with which two or more vehicles of the same manufacturer and the same model can be distinguished from each other when these vehicles are traveling side by side.

If the information relating to the ridesharing service obtained from the control device 41 of the drone 40 does not match the information embedded in the QR code (registered trademark) (NO in step S107), the process advances to step S117. Then, the control device 11 of the vehicle 10 notifies the control device 41 of the drone 40 that the vehicle is not the vehicle to which the load 80 should be delivered.

The process advances to step S118. Then, the control device 41 of the drone 40 obtains again the information relating to the order and the information relating to the ridesharing service from the second management server 30. The process advances to step S119. Then, according to the information obtained in the process in step S118, the control device 41 of the drone 40 causes the drone 40 to move to a position of the vehicle to which the load 80 is to be delivered. Thereafter, the process returns to step S106.

In step S108, the control device 11 of the vehicle 10 determines whether or not it is possible to receive the load 80. On the basis of a traveling state or a traveling environment of the vehicle 10, the control device 11 of the vehicle 10 can determine whether or not it is possible to receive the load 80. The traveling state of the vehicle 10 is, for example, a speed of the vehicle 10. In a specific example, in a case where the speed of the vehicle 10 is less than 30 km/h, the control device 11 of the vehicle 10 determines that it is possible to receive the load 80. Meanwhile, in a case where the speed of the vehicle 10 is not less than 30 km/h, the control device 11 of the vehicle 10 determines that it is impossible to receive the load 80. Note that the numerical value “30 km/h” is one example, and can be changed as appropriate.

The traveling environment of the vehicle 10 is, for example, a road where the vehicle 10 is traveling. In a specific example, in a case where the road where the vehicle 10 is traveling is a sharp curve or a steep slope, the control device 11 of the vehicle 10 determines that it is impossible to receive the load 80. Further, in a case where the road where the vehicle 10 is traveling is a bad road, the control device 11 of the vehicle 10 may determine that it is impossible to receive the load 80. The “bad road” herein may be a Belgian block road, a corrugated road, a gravel road, or the like. Meanwhile, in a case where the road where the vehicle 10 is traveling is a straight, flat paved road, the control device 11 of the vehicle 10 determines that it is possible to receive the load 80. Note that the control device 11 of the vehicle 10 can determine, on the basis of an image captured by the camera 13, what kind of road the vehicle 10 is traveling.

Further, by using both the traveling state condition and the traveling environment condition of the vehicle 10, the control device 11 of the vehicle 10 may determine whether or not it is possible to receive the load 80. For example, in a case where the speed of the vehicle 10 is less than 30 km/h and the road where the vehicle 10 is traveling is a straight, flat paved road, the control device 11 of the vehicle 10 may determine that it is possible to receive the load 80.

If the process in step S108 results in YES, the process advances to step S109. Then, the control device 11 of the vehicle 10 causes the opening and closing module 17 to slide toward the front side of the vehicle 10 so as to open the opening 81, which is a part of the roof (see FIG. 2).

The process advances to step S110. Then, the control device 11 of the vehicle 10 causes the ceiling module 16 to move from the opening 81 toward the outside of the vehicle 10 to reach a position where the load 80 can be placed on the ceiling module 16 (see FIG. 2).

The process advances to step S111. Then, after confirming the movement of the ceiling module 16 with the camera 43, the control device 41 of the drone 40 causes the load 80 to be placed on the ceiling module 16 and opens the arms 46 which have held the load 80. Consequently, delivery of the load 80 is completed.

If the process in step S108 results in NO, the process advances to step S120. Then, the control device 11 of the vehicle 10 calculates a timing suitable to receive the load 80. In a specific example, in a case where the vehicle 10 is traveling on a sharp curve, the control device 11 of the vehicle 10 calculates, as the timing to receive the load 80, a timing after the vehicle passes the sharp curve. In a case where the speed of the vehicle 10 is not less than 30 km/h, the control device 11 of the vehicle 10 may calculate, as the timing to receive the load 80, a timing when the speed of the vehicle 10 becomes less than 30 km/h.

If the timing calculated in step S120 comes within a predetermined period of time (YES in step S121), the process advances to step S122, and the control device 11 of the vehicle 10 notifies it to the control device 41 of the drone 40. The “predetermined period of time” herein is 30 seconds, for example. However, this is not limitative. Thereafter, the process advances to step S109.

If the timing calculated in step S120 does not come within the predetermined period of time (NO in step S121), the process advances to step S123, and the control device 11 of the vehicle 10 notifies it to the control device 41 of the drone 40. The process advances to step S124. Then, the control device 11 of the vehicle 10 causes the vehicle 10 to stop so that the load 80 is received. Thereafter, the process advances to step S109.

If the process in step S104 results in NO, the process advances to step S112. Then, the control device 41 of the drone 40 notifies the user 60 that it is impossible to deliver the load 80 to the vehicle 10 before the vehicle 10 arrives at the destination 85.

The process advances to step S113. Upon reception of the notification, the user 60 designates, on the application 741, a reception place where the load 80 is to be received and a desired reception time. The information input by the user 60 is transmitted to the first management server 20.

The process advances to step S114. Then, the first management server 20 obtains information indicative of the reception place and reception time transmitted in the process in step S113 so as to accept the designation made by the user 60. The first management server 20 transmits, to the second management server 30, the information indicative of the reception place and reception time designated by the user 60. Then, the second management server 30 transmits, to the control device 41 of the drone 40, the information indicative of the reception place and reception time designated by the user 60.

The process advances to step S115. Then, the control device 41 of the drone 40 calculates a flight route to the reception place obtained in the process in step S114.

The process advances to step S116. Then, the control device 41 of the drone 40 causes the drone 40 to fly along the flight route calculated in the process in step S115. At the reception place and reception time designated by the user 60, reception of the load 80 is completed.

If the process in step S104 results in NO, the control device 41 of the drone 40 may cancel the order made by the user 60, because it is impossible to deliver the load before the vehicle 10 arrives at the destination 85. In this case, the user 60 receives the notification that the order has been canceled.

In a case where a strong wind or heavy rain is recognized in an area around the drone 40, the control device 41 of the drone 40 may determine that flight is impossible and may cancel the order made by the user 60.

The flow of the processes described with reference to FIGS. 9 and 10 is merely an example. An unnecessary step(s) may be eliminated, a new step(s) may be added, or the order of the steps may be changed, without departing from the scope of the present invention. An entity executing each of the processes is not limited to those described above. Depending on the situation, each of the processes may be executed by the control device 11 of the vehicle 10, the first management server 20, the second management server 30, the control device 41 of the drone 40, or the user terminal 70.

### (Effects)

As discussed above, the foregoing embodiment provides the following effects.

The control device 11 of the vehicle 10 determines, on the basis of (i) an arrival time when the vehicle 10 will arrive at the destination 85 desired by the user 60 and (ii) a period of delivery time it takes for the drone 40 to deliver, to the vehicle 10, a product ordered by the user 60 who is traveling in the vehicle 10, whether or not it is possible for the drone 40 to deliver the product to the vehicle 10 before the vehicle 10 arrives at the destination 85.

If it is determined that the delivery is possible, the drone 40 will deliver the product. This makes it possible to deliver the product to the user 60 who is traveling. That is, the user 60 can receive the product while the user 60 is traveling. This contributes to increase in demand for shopping or demand for restaurants during traveling.

Further, if it is determined that it is possible for the drone 40 to deliver the product to the vehicle 10 before the vehicle 10 arrives at the destination 85, the control device 11 of the vehicle 10 may determine, on the basis of at least one of the traveling state of the vehicle 10 and the traveling environment of the vehicle 10, whether or not it is possible to receive the product from the drone 40. Furthermore, in a case where it is determined that it is impossible to receive the product, the control device 11 of the vehicle 10 may calculate, on the basis of at least one of the traveling state of the vehicle 10 and the traveling environment of the vehicle 10, a timing when it becomes possible to receive the product from the drone 40.

According to the above configuration, if it is difficult to receive the product from the drone 40, the control device 11 of the vehicle 10 does not control the ceiling module 16 and the opening and closing module 17 and does not permit reception of the product. Meanwhile, when conditions such as a condition that the speed of the vehicle 10 is less than a predetermined speed and a condition that the road where the vehicle 10 is traveling is a straight, flat paved road are satisfied, the product is received. This can reduce the possibility of breakage of the product.

### (Variations)

In the case explained above, if the process in step S108 in FIG. 10 results in YES, the control device 11 of the vehicle 10 controls the opening and closing module 17 and the ceiling module 16 so that the load 80 is received. Alternatively, before controlling the opening and closing module 17 and the ceiling module 16, the control device 11 of the vehicle 10 may calculate, in accordance with the user 60's request, a timing to receive the load 80 from the drone 40.

Specifically, if the process in step S108 in FIG. 10 results in YES, the control device 11 of the vehicle 10 may indicate, on the display 15 or the user terminal 70, arrival of the drone 40 so as to give a notification to the user 60. Upon reception of the notification, the user 60 determines whether to receive the load 80. This determination is made on the application 741, for example. If the user 60 wishes to receive the load 80, the control device 11 of the vehicle 10 controls the opening and closing module 17 and the ceiling module 16 so that the load 80 is received. According to this configuration, the user 60 can receive the load 80 at a timing desired by the user 60.

If the user 60 does not wish to receive the load 80, the user 60 may input his\her desired reception time.

In a case where the user 60 designates his/her desired reception time when the user 60 orders a product, the control device 11 of the vehicle 10 may indicate, a predetermined period of time (e.g., 10 minutes) before the reception time, the following message on the display 15: “The ordered product will arrive in 10 minutes.” In this manner, the control device 11 of the vehicle 10 may give a notification to the user 60. Assume that the desired reception time is 12:00. In this case, the time when the notification is given to the user 60 is 11:50. When the user 60 who has received the notification wishes to delay the reception time, the user 60 may change the desired reception time on the application 741. For example, the user 60 can change the desired reception time from 12:00 to 12:15. Information indicating the changed time is transmitted to the control device 41 of the drone 40. The control device 41 of the drone 40 causes the drone 40 to fly so that the drone 40 will arrive at the vehicle 10 at the changed time. According to this configuration, the user 60 can receive the load 80 at a timing desired by the user 60.

### [Software Implementation Example]

The function as the first management server 20, the second management server 30, the control device 11 of the vehicle 10, the control device 41 of the drone 40, or the user terminal 70 can be realized by a program causing a computer to function as the first management server 20, the second management server 30, the control device 11 of the vehicle 10, the control device 41 of the drone 40, or the user terminal 70, the program causing the computer to function as each control block of the first management server 20, the second management server 30, the control device 11 of the vehicle 10, the control device 41 of the drone 40, or the user terminal 70.

In this case, the first management server 20, the second management server 30, the control device 11 of the vehicle 10, the control device 41 of the drone 40, or the user terminal 70 includes a computer including at least one device (e.g., a processor) and at least one storage device (e.g., a memory) as hardware for executing the program. The computer executes the program to realize the functions described in the foregoing embodiments.

The program may be stored in one or more non-transitory, computer-readable storage media. The one or more storage media may or may not be included in the first management server 20, the second management server 30, the control device 11 of the vehicle 10, the control device 41 of the drone 40, or the user terminal 70. In the latter case, the program can be supplied to the first management server 20, the second management server 30, the control device 11 of the vehicle 10, the control device 41 of the drone 40, or the user terminal 70 via any wired or wireless transmission medium.

Some or all of the functions of the control blocks can be realized by a logic circuit. For example, an integrated circuit in which a logic circuit that functions as the control blocks is formed is also encompassed in the scope of the present disclosure. In addition, the function of the control blocks can be realized by, for example, a quantum computer.

Further, each of the processes described in the foregoing embodiments can be executed by artificial intelligence (AI). In this case, the AI may be operated by the first management server 20, the second management server 30, the control device 11 of the vehicle 10, the control device 41 of the drone 40, or the user terminal 70 or may be operated by another device (for example, an edge computer or a cloud server).

The present disclosure is not limited to the foregoing embodiments, but can be altered by a skilled person in the art within the scope of the claims.

### REFERENCE SIGNS LIST

100: delivery management system
10: vehicle
11: control device
40: drone

1. A control device comprising:
a controller;
the controller determining, on a basis of (i) an arrival time when a vehicle will arrive at a destination desired by a user and (ii) a period of delivery time it takes for a drone to deliver, to the vehicle, a product ordered by the user who is traveling in the vehicle, whether or not it is possible for the drone to deliver the product to the vehicle before the vehicle arrives at the destination.

2. The control device according to claim 1, wherein:
in a case where it is determined that it is possible for the drone to deliver the product to the vehicle before the vehicle arrives at the destination, the controller determines, on a basis of at least one of a traveling state of the vehicle and a traveling environment of the vehicle, whether or not it is possible to receive the product from the drone.

3. The control device according to claim 2, wherein:
in a case where it is determined that it is impossible to receive the product, the controller calculates, on a basis of at least one of the traveling state of the vehicle and the traveling environment of the vehicle, a timing when it becomes possible to receive the product from the drone.

4. The control device according to claim 1, wherein:
in a case where it is determined that it is possible for the drone to deliver the product to the vehicle before the vehicle arrives at the destination, the controller calculates, in accordance with a request of the user, a timing to receive the product from the drone.

5. A control method for use in a control device that includes a controller, the control method comprising the step of:
determining, on a basis of (i) an arrival time when a vehicle will arrive at a destination desired by a user and (ii) a period of delivery time it takes for a drone to deliver, to the vehicle, a product ordered by the user who is traveling in the vehicle, whether or not it is possible for the drone to deliver the product to the vehicle before the vehicle arrives at the destination.

6. A computer-readable storage medium having a control program stored therein, the control program causing a computer to execute a process of determining, on a basis of (i) an arrival time when a vehicle will arrive at a destination desired by a user and (ii) a period of delivery time it takes for a drone to deliver, to the vehicle, a product ordered by the user who is traveling in the vehicle, whether or not it is possible for the drone to deliver the product to the vehicle before the vehicle arrives at the destination.
